(19) United States
(12) Patent Application Publication
(10) Pub. No.: US 2007/0056295 A1
(43) Pub. Date: Mar. 15, 2007

(54) Solid-state water cooler

(75) Inventor: Roger S. De Vilbiss, Wichita Falls, TX (US)

Correspondence Address: BAKER BOTTS L.L.P., 2001 ROSS AVENUE, SUITE 600, DALLAS, TX, 75201-2980, US

(73) Assignee: ALMONT DEVELOPMENT, LTD.

(21) Appl. No.: 11/225,802

(22) Filed: Sep. 13, 2005

(51) Int. Cl. F25B 21/02; B67D 5/62

(52) U.S. Cl. 62/3.64; 62/389

(57) ABSTRACT

In one embodiment of the invention, a system for controlling the temperature of water in a water cooler includes a water reservoir having an inlet, an outlet, and a main body, a water supply coupled to the inlet and operable to deliver water to the water reservoir, a bubbler coupled to the outlet and operable to dispense at least some of the water from the water reservoir, and a plurality of thermoelectric coolers disposed about a perimeter of the main body and operable to control the temperature of the water inside the water reservoir.

### BACKGROUND OF THE INVENTION

There are four basic types of water or drink dispensers: bottled water dispensers, point-of-use dispensers, pressurized water dispensers and soft drink fountains. Bottled water dispensers manually replace a bottle to supply the water. Point-of-use dispensers are freestanding appliances that use line pressure activated by a float switch to maintain a water level. Pressurized water dispensers, also know as refrigerated water fountains, are typically installed in non-residential buildings and are purchased at the time of construction.

Current designs for the above dispensers use small compressor-based cooling systems that dissipate the heat to ambient via forced air. An evaporator cools a reservoir and the condenser/fan arrangement dissipates the heat. This approach, depending on the size of the cooling system, consumes energy, produces noise, and then dissipates this heat into an air conditioned environment, which adds cooling costs to the building. Since this approach uses a fan to dissipate the heat to the environment, noise and vibration is generated and air is circulated in and around the water cooler that is unwarranted in many school, manufacturing, office or hospital applications.

Thermoelectric coolers are sometimes used to actively cool the “cold” reservoir in bottled water and point-of-use dispensers. However, prior systems only use a single thermoelectric cooler that are inefficient and can only cool applications that consume water at less than about one GPH of 50° F. water. In addition, these designs only actively cool a small percentage of the cold reservoir making insulation a critical factor in system efficiency. Compressor-based water cooler designs typically use a compressor that consumes around 500 Watts of power every time that it is activated to maintain a reservoir at 50° F.

### SUMMARY OF THE INVENTION

In one embodiment of the invention, a system for controlling the temperature of water in a water cooler includes a water reservoir having an inlet, an outlet, and a main body, a water supply coupled to the inlet and operable to deliver water to the water reservoir, a bubbler coupled to the outlet and operable to dispense at least some of the water from the water reservoir, and a plurality of thermoelectric coolers disposed about a perimeter of the main body and operable to control the temperature of the water inside the water reservoir.

Embodiments of the invention provide a number of technical advantages. Embodiments of the invention may include all, some, or none of these advantages. In one embodiment, a solid-state water cooler provides improved operational efficiency by consuming lower power and, thus, saves on energy bills. Such a water cooler may be compact and have no moving parts, which facilitates quiet operation and reduces wear and tear. In addition, no air movement or associated air filter is required to discharge heat into the environment.

In one embodiment, a system is disclosed that operates multiple thermoelectric coolers with an efficient standby power level that allows natural convection cooling to maintain the reservoir water at the specified set point. Such a system uses a cost-effective and efficient full power application, in conjunction with water cooling the hot sides of the thermoelectric coolers for heavy demand scenarios, which occur a small percentage of the time. In some embodiments, the system requires no forced air flow that causes noise, vibration and particulate flow within the air that might be unwarranted at many hospital, school, or manufacturing environments. In addition, a combination water filter/bubbler provides filtered water with an easy filter change.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a schematic of a solid-state water cooler according to one embodiment of the invention;

FIG. 2 is a perspective view of a water reservoir for use in the solid-state water cooler of FIG. 1 according to one embodiment of the invention;

FIG. 3 is a cross-section of the water reservoir of FIG. 1 according to one embodiment of the invention;

FIG. 4 is a schematic of a water filter/bubbler combination unit according to one embodiment of the invention;

FIG. 5 is a schematic of a dual power supply approach using an AC/DC non-isolated power supply for full power and a AC/DC power supply for standby power;

FIG. 6 is a flowchart illustrating a method of operating a solid-state water cooler according to one embodiment of the invention; and

FIG. 7 is a schematic of a water reservoir system for use in a solid-state water cooler according to one embodiment of the invention.

### DETAILED DESCRIPTION OF EXAMPLE EMBODIMENTS OF THE INVENTION

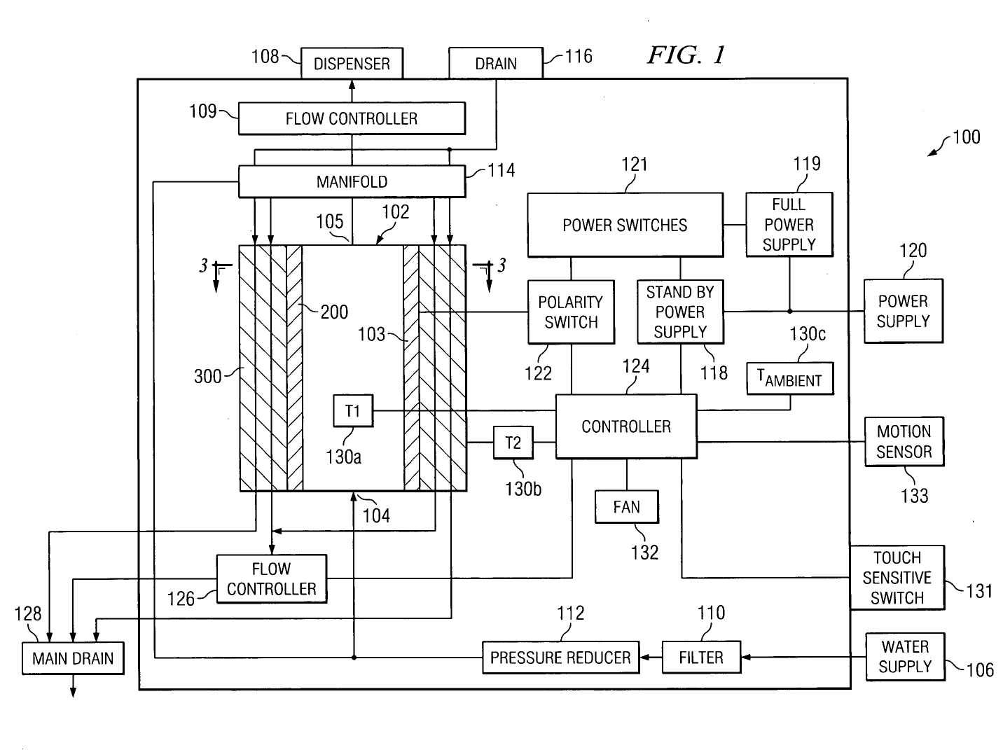

Example embodiments of the present invention and their advantages are best understood by referring now to FIGS. 1 through 7 of the drawings.

FIG. 1 is a schematic of a solid state water cooler 100 according to one embodiment of the invention. The present invention as described herein is applicable for any suitable water cooler, such as a pressurized water dispenser, a point-of-use water dispenser, a bottle water dispenser, and other devices that store and utilize cooled water. In the illustrated embodiment, water cooler 100 includes a water reservoir 102 having an inlet 104, an outlet 105, and a main body 103. Water reservoir 102 receives water from a water supply 106 and is dispensed via a dispenser 108 when a user desires water.

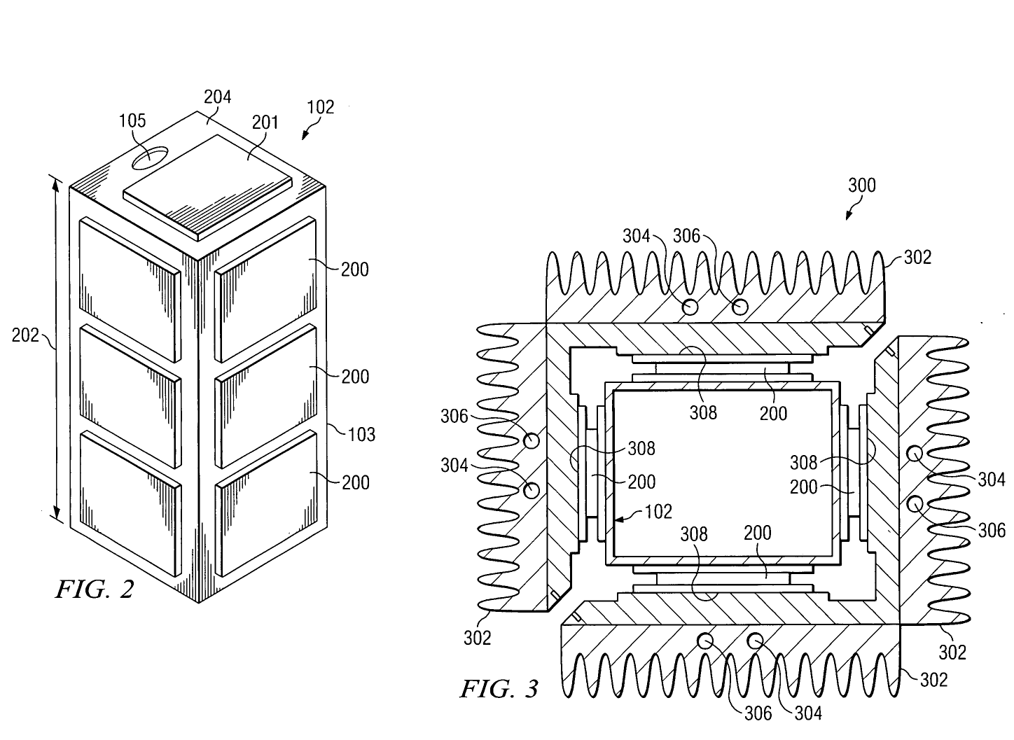

According to the teachings of one embodiment of the invention, water reservoir 102 has a plurality of thermoelectric coolers 200 disposed about a perimeter of main body 103 that are operable to control the temperature of the water inside water reservoir 102. Thermoelectric coolers 200 are described in further detail below in conjunction with FIG. 2.

Water cooler 100, as illustrated in FIG. 1, also includes a heat exchanger 300 coupled to thermoelectric coolers 200. Heat exchanger 300 is described in further detail below in conjunction with FIG. 3. In addition, water cooler 100 also includes one or more filters 110, a pressure reducer 112, a manifold 114, a drain 116, a standby power supply 118 and full power supply 119 coupled to power supply 120, power switches 121, a polarity switch 122, a controller 124, a flow controller 126, a main drain 128, a plurality of temperature sensors 130, an optional fan 132, and a motion sensor 133. The present invention contemplates more, fewer, or different components for water cooler 100 than those shown in FIG. 1.

Water supply 106 may be any suitable supply of water. Typically, water supply 106 is water existing in a pressurized line that runs to a residence or commercial building. Water from water supply 106 enters water cooler 100 and is filtered by a large particle water filter 110 before being delivered to a pressure reducer 112 in order to reduce the pressure of the water from water supply 106. The water may then be filtered again if so desired before being delivered to water reservoir 102. In one embodiment, after the pressure of the water is reduced by pressure reducer 112 to any suitable amount, at least some of the water may be delivered to a manifold 114 where it is stored and subsequently used in heat exchanger 300, as described in further detail below.

Water that is stored in water reservoir 102 is cooled by thermoelectric coolers 200 and maintained at a predetermined temperature during a standby mode when water cooler 100 is not in use. Any suitable predetermined temperature is contemplated by the present invention. However, in one embodiment, the water in water reservoir 102 is maintained at a temperature of 50° F.±3° F. The amount of power delivered to thermoelectric coolers 200 by standby power supply 118 or full power supply 119 determines the temperature of water within water reservoir 102.

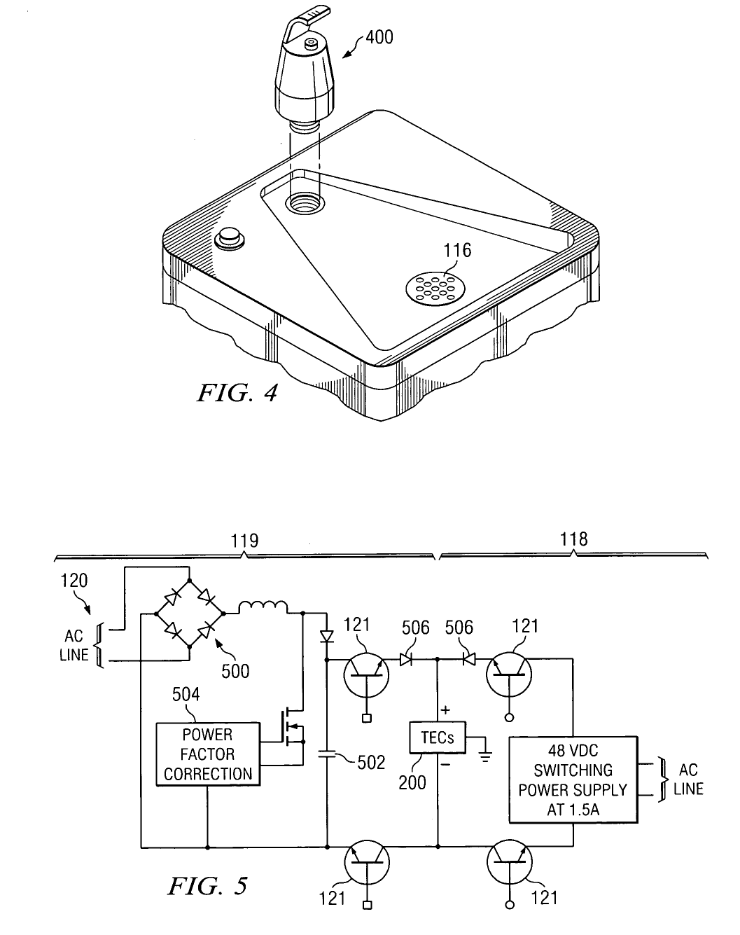

When a user desires to obtain water from water cooler 100, a user uses dispenser 108 in order to obtain the water from water reservoir 102 via flow controller 109. Any suitable dispenser is contemplated by the present invention; however, in one embodiment, dispenser 108 is a bubbler that is found on many pressurized water coolers. In a particular embodiment of the invention as shown in FIG. 4, dispenser 108 is a replaceable water filter/bubbler combination unit 400 that may couple to water cooler 100 in any suitable manner, such as a screwed connection for ease of replacement.

In some embodiments, a touch sensitive switch 131 may be utilized to control flow controller 109 in order to dispense water from water reservoir 102. Touch sensitive switch 131 turns flow controller 109 on and off and meets the American Disabilities Act requirements. As one example, touch sensitive switch 131 may be one of the QT110 Family Qtouch™ Sensor ICs by Quantum Research Group.

At least some of the water that is being dispensed is collected and drained by drain 116 that is diverted to either main drain 128 or, in some embodiments, may be utilized within heat exchanger 300 for cooling thermoelectric coolers 200, as described in greater detail below. During the use mode, when a user is obtaining water through dispenser 108, additional power may be delivered to thermoelectric coolers 200 by either full power supply 119 or standby power supply 118 in order to keep the water within water reservoir 102 at the desired temperature. This is because as water is being dispensed by dispenser 108, additional water from water supply 106 that is at a higher temperature than the desired temperature is being supplied to water reservoir 102.

As described in further detail below, water may flow proximate the hot side of thermoelectric coolers 200 if the temperature of such water is cooler than the ambient temperature to improve system performance. If the water does not provide adequate cooling in a low power use mode within a certain time frame, full power supply 119 or standby power supply 118 may then be used to cool the temperature of water reservoir 102 to the desired temperature. If the temperature of water reservoir 102 drops below a predetermined threshold, e.g. 46° F., power to thermoelectric coolers 200 may be turned off and heating may be used if the ambient temperature drops below freezing (32° F.).

Although any suitable power delivery is contemplated by the present invention, in the illustrated embodiment, power is delivered to thermoelectric coolers 200 via one of two power supplies 118 or 119 via power supply 120, which may come from a standard wall socket or power cord. A fuse or circuit breaker (not illustrated) may be used to provide safety protection.

FIG. 5 is a schematic of a dual power supply approach according to one embodiment of the invention using an AC/DC non-isolated power supply for full power supply 119 and a AC/DC power supply for standby power supply 118. To switch between full power supply 119 and standby power supply 118, transistors switches 121 are utilized in the illustrated embodiment to isolate the positive leg and return legs of each power supply from each other. One power supply may be turned on at a time or both may be turned off. Diodes 506 may also be utilized to protect current from flowing the wrong way.

Power supply 120 may be rectified by a bridge rectifier 500 and filtered with a capacitor 502 to provide a non-isolated DC power to drive thermoelectric coolers 200 under a “full” power condition. For example, the DC voltage may range between 150 and 170 VDC in full power supply 119 when connected to a 115 VAC±10% power line (power supply 120). In one embodiment, bridge rectifier 500 includes four diodes that take a sinusoidal waveform input and inverts the negative going portion of the wave providing an all positive waveform ∩∩∩∩∩, with the peaks at @ 160 Volts. Filter capacitor 502 is sized to the current capacity of thermoelectric coolers 200 such that there is typically less than a 10% ripple on the average output of capacitor 502. The capacity takes the ∩∩∩∩∩ and turns it into a DC voltage, (1.414×120 VAC=160 VDC). An optional power factor correction circuit 504 may help to balance out the voltage and current draw from the line.

Standby power supply 118 is an isolated switching power supply that delivers “maintenance” power to thermoelectric coolers 200. This maintenance power is used to minimize the thermal short that exists and provides low power cooling to maintain water in water reservoir 102 at the desired temperature. In one embodiment, standby power supply 118 may provide 12, 24, 36 or 48 VDC and less than about 65 Watts to thermoelectric coolers 200. In current designs, compressors are thermostatically controlled and consume around 500 Watts when they are activated versus 65-75 Watts in this invention. Any suitable method may be utilized according to the teachings of the invention to achieve power levels necessary to exceed competitive performance requirements or ENERGY STAR requirements. For example, an additional 15 Watt supply could be used to apply a very small amount of power to minimize the thermal short that would exist within thermoelectric coolers 200 during an off cycle. In some embodiments, a suitable fuel cell may be utilized to power the thermoelectric coolers and other functions of the water cooler instead of AC power source 120.

Referring back to FIG. 1, a polarity switch 122 may be utilized to reverse the polarity of thermoelectric coolers 200 in order to change from cooled water to hot water or hot water to cooled water. For example, if water is maintained at approximately 50° F. in water reservoir 102 and the user desires hot water, then polarity switch 122 may switch the polarity of thermoelectric coolers 200 in order to heat the water. Any suitable amount of heating in any suitable amount of time is contemplated by the present invention.

A suitable controller 124 may be utilized to control the power delivered to thermoelectric coolers 200 in addition to controlling other functions of water cooler 100, such as the switching of the power supplies via switches 121, the switching of the polarity delivered to thermoelectric coolers 200, the use of heat exchanger 300, optional fan 132, and other suitable functions. Any suitable controller is contemplated by the present invention. Independent analog circuitry may also be utilized.

Controller 124 may be coupled to temperature sensors 130a, 130b, 130c in order to maintain the temperature of the water in water reservoir 102 under different environmental and use conditions. For example, if ambient temperature rises, as detected by temperature sensor 130c, then more than likely the temperature of water in water reservoir 102, as detected by temperature sensor 130a, will rise. Controller 124 may then either direct more power to be delivered to thermoelectric coolers 200 or direct drain water from drain 116 or water stored in manifold 114 through heat exchanger 300 in order to keep the temperature of the water within water reservoir 102 at the desired temperature.

Fan 132 may also be used for forced convection across heat exchanger 300 for additional cooling purposes. Any suitable fan, such as a DC fan, is contemplated by the present invention. One advantage of the present invention is that during standby mode, natural convection may be the only convection needed for maintaining the temperature of water within water reservoir 102 at the desired temperature.

Flow controller 126 is coupled to main drain 128 and controls the flow of water through heat exchanger 300. Any suitable flow controller, such as a suitable solenoid valve, may be utilized. Generally, flow controller 126 may direct that only drain water from drain 116 be directed through heat exchanger 300, or may direct that only water stored in manifold 114 be directed through heat exchangers 300.

Motion sensor 133 may be any suitable motion detection device coupled to controller 124 in order to control power supplies 118, 119. For example, if motion sensor 133 detects no movement within a predetermined time period, then controller 124 may switch the power delivery to thermoelectric coolers 200 from full power supply 119 to standby power supply 118 or from standby power supply to zero power delivery. Any suitable time period is contemplated by the present invention and any suitable control of power supplies 118, 119 is also contemplated by the present invention.

FIG. 2 illustrates a perspective view of water reservoir 102 according to one embodiment of the invention. Main body 103 of water reservoir 102 may have any suitable size and shape and may be formed from any suitable material. For example, as illustrated in FIG. 2, main body 103 may be rectangularly shaped and be formed from aluminum. In other embodiments, main body 103 is formed from other suitable metals, such as copper or stainless steel utilizing coatings, if necessary, to meet NSF-ANSI-61 requirements. In one particular embodiment of the invention, the approximate dimensions of main body 103 are two inch width by two inch depth by approximately twelve inches long. Although not illustrated in FIG. 2, water reservoir 102 may include baffles therein for effective distribution of temperature.

Alternatively, in one particular embodiment, an approach may be to sandwich sixteen thermoelectric coolers 200 in a 0.5″ thick×1.6″×14″ water manifold with thermoelectric coolers 200 and two heat sinks on each side that are 1.8″ wide×14″ long while maximizing the coverage of the thermoelectric coolers 200 around the reservoir. Counter flow of the cooling water to the reservoir water may be used in this embodiment as well as previous embodiments.

The thermoelectric coolers 200 coupled to the outside surface of main body 103 cover a significant portion of the surface area of main body 103. Thus, depending on the type of thermoelectric coolers utilized, thermoelectric coolers 200 may be disposed about a perimeter of, as well as along a length 202 of, main body 103. Preferably, the gaps between thermoelectric coolers 200 are minimized so as to minimize any thermal shorts from water reservoir 102 to the heat sinks of main body 103. Additional thermoelectric coolers, such as thermoelectric cooler 201, may be coupled to a top 204 of water reservoir 102 or a bottom of water reservoir 102.

Any suitable thermoelectric coolers are contemplated by the present invention. However, in one particular embodiment of the invention, each of the thermoelectric coolers are model number DT12-6-10L manufactured by Marlow Industries. Thermoelectric coolers 200 may be coupled to main body 103 in any suitable manner and any suitable number of thermoelectric coolers 200 are contemplated by the present invention. In one embodiment, between thirteen and sixteen thermoelectric coolers 200 are utilized for controlling the temperature of the water within water reservoir 102. Preferably, thermoelectric coolers 200 are electrically coupled in series to take advantage of the low cost and efficient line rectified full power voltage.

FIG. 3 illustrates a cross-section of water reservoir 102 according to one embodiment of the invention. As illustrated in FIG. 3, heat exchanger 300 has a plurality of fins 302 coupled thereto and is coupled to a hot side 308 of each thermoelectric cooler 200. (This is assuming that the thermoelectric coolers are being used to cool the water inside water reservoir 102.) Heat exchanger 300 may be formed from any suitable material and may have any suitable size and shape. In one embodiment, during maintenance power conditions, heat exchanger 300 with fins 302 provide enough surface area for natural convection to keep the hot sides 308 of thermoelectric coolers 200 at a low enough temperature to provide water within water reservoir 102 at the desired set point. However during use conditions, it may be necessary to provide additional cooling to the hot side 308 of thermoelectric coolers 200 by either forced convection via fan 132 or by running water through heat exchanger 300.

For example, heat exchanger 300 includes a first set of cooling channels 304 and a second set of cooling channels 306. Cooling channels 304 are coupled to drain 116 (FIG. 1) and are operable to flow water from drain 116 through heat exchangers 300 in order to provide cooling to hot side 308 of thermoelectric coolers 200. On the other hand, cooling channels 306 are coupled to manifold 114 (FIG. 1) and are operable to flow water stored in manifold 114 that comes from water supply 106 through heat exchanger 300 for the cooling of hot side 308 of thermoelectric coolers 200. The use of either cooling channels 304, cooling channels 306, or both, may be controlled by controller 124 (FIG. 1). The drain water may also be used to precool the water prior to entrance into water reservoir 102; however, a preferred embodiment is illustrated.

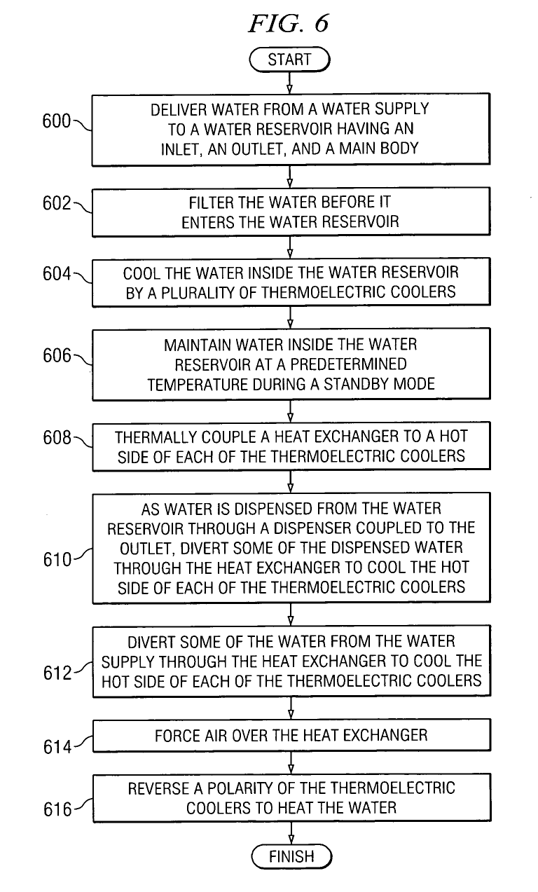

FIG. 6 is a flowchart illustrating an example method of operating a solid state water cooler according to one embodiment of the invention. The example method begins at step 600 where water from water supply 106 is delivered to water reservoir 102 having inlet 104, outlet 105, and main body 103. As described above, the water may be filtered, as indicated by step 602, before it enters water reservoir 102. The water inside water reservoir 102 is cooled, at step 604, by thermoelectric coolers 200 disposed about a perimeter of main body 103. Thermoelectric coolers 200 maintain the water inside water reservoir 102 at a predetermined temperature during a standby mode, as indicated by step 606.

Heat exchanger 300 is thermally coupled to a hot side 308 of each of thermoelectric coolers 200, at step 608. During a use mode, as water is dispensed from water reservoir 102 through dispenser 108 coupled to outlet 105, some of the dispensed water is diverted through heat exchanger 300 by a drain 116 to cool the hot side 308 of each of the thermoelectric coolers 200, as indicated by step 610. In addition, as described above, some of the water from water supply 106 may be diverted through heat exchangers 300 for the same purpose, as indicated by step 612. As an additional cooling method or option, air may be forced over heat exchanger 300 by fan 132, as indicated by step 614. And when a user desires hot water instead of cool water from water cooler 100, a plurality of thermoelectric coolers 200 may be reversed to heat the water, as indicated by step 616. This then ends the example method outlined in FIG. 6.

Thus, the solid state water cooler according to one embodiment of the invention provides improved operational efficiency by consuming lower power and saving on energy bills. Some embodiments facilitate a compact water cooler with no moving parts, which facilitates quiet operation and reduces wear and tear. In addition, no forced air is needed, thus eliminating the need for air filters, noise baffling or circulation of unhealthy contaminants in the air.

In one embodiment, test data indicates three volts per chip (@ 65 Watts) on sixteen chips may provide enough cooling to maintain a water reservoir at or below 50° F. in an 85° F. environment. With ten volts per thermoelectric cooler (@ 435 Watts) supplied and water cooled, the reservoir may be cooled back down to 50° F. or below within three to five minutes, providing a near one pass cooling of the incoming water during high usage scenarios.

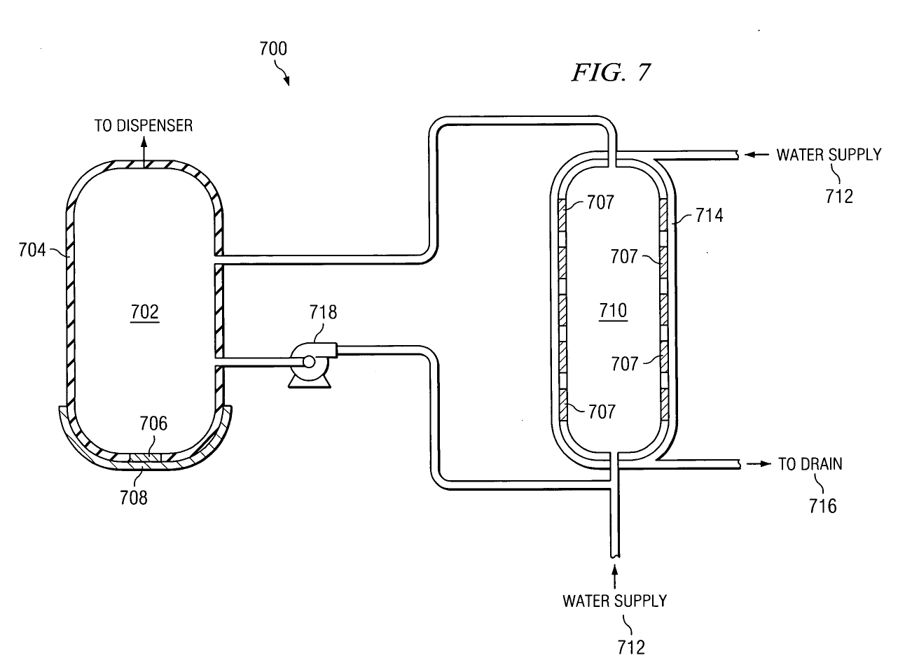

FIG. 7 is a schematic of a water reservoir system 700 for use in a solid-state water cooler according to another embodiment of the invention. In this embodiment, a maintenance reservoir 702 includes any suitable insulation 704 and one TEC 706 coupled to an outside surface thereof. In the illustrated embodiment, TEC 706 is coupled to a bottom of reservoir 702; however, other suitable locations are contemplated by the present invention. A suitable heat sink 708 is coupled to the hot side of TEC 706 to help remove heat generated by TEC 706.

TEC 706, which may be similar to TECs 200 discussed above, is utilized to cool the water within maintenance reservoir 702 and maintain the water therein at a desired temperature (e.g., 50° F.±3° F.) with the help of insulation 704 and natural convection cooling. In one embodiment, the single TEC 200 may accept a power of twelve volts and may cool water therein to 50° F. in a 90° F. ambient environment. Maintenance reservoir 702 may be any suitable size and shape and be formed from any suitable material.

Water reservoir 702 receives water from a secondary water reservoir 710, which receives supply water from a suitable water supply 712. Secondary water reservoir 710 may be any suitable size and shape and be formed from any suitable material and includes a plurality of TEC's 707 surrounding an outside surface thereof. A suitable heat exchanger 714 is coupled to the hot side of each thermoelectric cooler 707 and receives cooling water from water supply 712. After traveling through heat exchanger 714, the cooling water exits to a drain 716. TECs 707 are operable to cool the water within reservoir 710 to any suitable temperature in any suitable amount of time and in any suitable environment. Any suitable power may be delivered to TECs 707, such as one volt per TEC.

In one embodiment of FIG. 7, maintenance reservoir 702 may be utilized, by using a suitable pump 718, to recirculate some of the water therein through secondary water reservoir 710 for additional cooling purposes when needed. The recirculated water may enter secondary water reservoir 710 through the bottom and exit out the top before being returned to maintenance reservoir 702.

Although embodiments of the invention and their advantages are described in detail, a person skilled in the art could make various alterations, additions, and omissions without departing from the spirit and scope of the present invention.

What is claimed is:

1. A system for controlling the temperature of water in a water cooler, comprising:
a water reservoir having an inlet, an outlet, and a main body;
a water supply coupled to the inlet and operable to deliver water to the water reservoir;
a dispenser coupled to the outlet and operable to dispense at least some of the water from the water reservoir; and
a plurality of thermoelectric coolers disposed about a perimeter of the main body and operable to control the temperature of the water inside the water reservoir.

2. The system of claim 1, wherein the water cooler is selected from the group consisting of a pressurized water dispenser, and point-of-use water dispenser, and a bottled water dispenser.

3. The system of claim 1, wherein the main body is rectangularly shaped and the thermoelectric coolers are spaced about the perimeter of the main body as well as longitudinally spaced along the main body.

4. The system of claim 1, further comprising an additional thermoelectric cooler coupled to a top of the main body near the outlet.

5. The system of claim 1, wherein the thermoelectric coolers are operable to maintain water inside the water reservoir at a temperature of approximately 50° F. at an ambient temperature between approximately 10° F. and 85° F. during a standby mode.

6. The system of claim 1, wherein the main body is formed from aluminum.

7. The system of claim 1, wherein the plurality of thermoelectric coolers comprises between thirteen and sixteen thermoelectric coolers.

8. The system of claim 1, wherein the dispenser comprises a replaceable water filter/bubbler combination unit.

9. A system for controlling the temperature of water in a water cooler, comprising:
a water reservoir having an inlet, an outlet, and a main body;
a water supply coupled to the inlet and operable to deliver water to the water reservoir;
a dispenser coupled to the outlet and operable to dispense at least some of the water from the water reservoir;
a plurality of thermoelectric coolers disposed about a perimeter of, and along a length of, the main body and operable to control the temperature of the water inside the water reservoir;
a heat exchanger having a plurality of fins thermally coupled to a hot side of each of the thermoelectric coolers;
a first set of cooling channels coupled to the heat exchanger and operable to flow dispensed water therethrough to cool a hot side of each of the thermoelectric coolers; and
a second set of cooling channels coupled to the heat exchanger and operable to flow at least some of the water from the water supply therethrough to cool a hot side of each of the thermoelectric coolers.

10. The system of claim 9, further comprising a first power supply operable to deliver a first power to the thermoelectric coolers during a standby mode and a second power supply operable to deliver a second power to the thermoelectric coolers during a use mode.

11. The system of claim 10, further comprising a motion sensor operable to control the first and second power supplies.

12. The system of claim 9, further comprising a polarity switch operable to, when directed by a controller, reverse the polarity of the thermoelectric coolers.

13. The system of claim 9, further comprising a replaceable filter coupled between the water supply and the inlet.

14. The system of claim 9, wherein the dispenser comprises a replaceable water filter/bubbler combination unit.

15. The system of claim 9, further comprising a fan operable to, when directed by a controller, force air over the heat exchanger.

16. The system of claim 9, further comprising a manifold operable to contain the at least some of the water from the water supply before flowing through the second set of cooling channels.

17. The system of claim 9, further comprising:
a first temperature sensor operable to sense a temperature of the water inside the water reservoir;
a second temperature sensor operable to sense an ambient temperature; and
a third temperature sensor operable to sense a temperature of the heat exchanger.

18. A method for controlling the temperature of water in a water cooler, comprising:
delivering water from a water supply to a water reservoir having an inlet, an outlet, and a main body;
cooling the water inside the water reservoir by a plurality of thermoelectric coolers disposed about a perimeter of the main body;
thermally coupling a heat exchanger to a hot side of each of the thermoelectric coolers; and
as water is dispensed from the water reservoir through a dispenser coupled to the outlet, diverting some of the water from the water supply through the heat exchanger to cool the hot side of each of the thermoelectric coolers.

19. The method of claim 18, further comprising diverting some of the dispensed water through the heat exchanger to cool the hot side of each of the thermoelectric coolers.

20. The method of claim 18, further comprising forcing air over the heat exchanger.

21. The method of claim 18, further comprising reversing a polarity of the thermoelectric coolers to heat the water to a temperature of approximately 165° F.

22. The method of claim 18, further comprising filtering the water before the delivering step.

23. The method of claim 18, further comprising maintaining water inside the water reservoir at a temperature of approximately 50° F. at an ambient temperature between approximately 110° F. and 85° F. during a standby mode.

24. The method of claim 18, further comprising, after water is finished being dispensed from the water reservoir through the dispenser, purging any water within the heat exchanger.
